(19) United States
(12) Patent Application Publication
(10) Pub. No.: US 2005/0160258 A1
(43) Pub. Date: Jul. 21, 2005

(54) Detecting objectionable content in displayed images

(75) Inventors: Donal O'Shea, Mornington (IE); Dara Fitzgerald, Clane (IE)

Correspondence Address: TESTA, HURWITZ & THIBEAULT, LLP, HIGH STREET TOWER, 125 HIGH STREET, BOSTON, MA, 02110, US

(73) Assignee: BioObservation Systems Limited, Dublin (IE)

(21) Appl. No.: 11/008,867

(22) Filed: Dec. 10, 2004

(30) Foreign Application Priority Data
Dec. 11, 2003 (IE) 2003/0926

(51) Int. Cl. H04N 9/78

(52) U.S. Cl. 713/154; 725/25

(57) ABSTRACT

The disclosed technology can detect objectionable content in a displayed image. Pixel groupings associated with the displayed image can be analyzed in response to one or more intercepted messages associated with a window that displays the image and a probability that the displayed image includes objectionable content can be subsequently computed. This probability can serve as a basis for classifying the displayed image as objectionable.

### RELATED APPLICATIONS

This claims priority to and the benefit of Irish Preliminary Patent Application No. 2003/0926 filed Dec. 11, 2003, the entirety of which is incorporated herein by reference.

### TECHNICAL FIELD

The disclosed technology relates generally to analyzing electronic images, and more particularly to detecting objectionable content within such images.

### BACKGROUND

As the electronic delivery of information is provided, packaged, and/or presented in increasingly sophisticated and complex ways, it becomes correspondingly more difficult to detect and control the presentation and/or dissemination of certain types of objectionable content contained within such information. For example, a minor child's guardian or parent may find a graphical image containing pornographic, sexually explicit, violent, or other types of objectionable content (received from, for example, a network, DVD, CD, scanner, digital camera, or the like) to be unsuitable for the minor and would therefore seek to reduce or eliminate the frequency with which such content is displayed to the minor. Similarly corporations and other types of organizations, as well as their officers and directors, may be subject to criminal liability and/or civil sanctions under legal statutes that restrict the possession, display, and/or dissemination of certain types of objectionable content within an organization or between an organization and another entity.

Traditional attempts at detecting and restricting the presentation and/or dissemination of objectionable content have involved, for example, preventing access to or receipt of data from image sources that typically provide such objectionable content, executing algorithms that detect the shape of a human body or its parts, evaluating metadata accompanying or otherwise being associated with the objectionable content, scanning textual information to detect key words, and/or other types of techniques that seek to detect and restrict the dissemination of objectionable content prior to or at its point of entry into a protected space.

Recent advancements in this technology area assume that some objectionable content will penetrate into the protected space regardless of the precautions taken at the point of entry and thus seek to periodically or randomly evaluate a user's display and/or processing device for indicia of such objectionable content. Unfortunately, advancements of this sort may be computationally intensive and/or network intensive and may therefore usurp valuable computing/networking resources without providing a satisfactory degree of objectionable content detection. Accordingly, individuals, organizations, and other types of entities interested in detecting and controlling the presentation and/or dissemination of objectionable content have a continuing interest in developing and/or using a computationally-efficient method for detecting objectionable content within images that further improves the accuracy of such detection within a protected space of interest.

### SUMMARY

The disclosed technology provides a computationally-efficient method for detecting objectionable content within images that may be displayed on a display screen of a digital data processing device by, at least in part, using a screen interception and image monitoring/analysis technique to evaluate images after or concurrently with their display on the display screen. The disclosed technology is not affected by the source of the images, because regardless of how or wherefrom the images are received, they are rendered and eventually all displayed by the digital data processing device. Accordingly, image analysis occurring at this presentation stage need not be encumbered with understanding particular file formats, analyzing accompanying metadata, identifying known sources of objectionable content, or scanning for key words as is common in prior art systems that evaluate images prior to their presentation. Similarly, identifying the formation of windows that display images coupled with intercepting user interactions associated with the displayed images, enables the disclosed technology to analyze the content of images that may have been previously neglected by prior art systems that perform random or periodic screen shot evaluations. The disclosed technology can also be operated in an unobtrusive manner, such that a user need not even know that image analysis is occurring and so that computing/network resources are not significantly burdened.

In one illustrative embodiment, the disclosed technology provides a system for execution on a digital data processing device (e.g., a computer) to provide comprehensive protection from illegal and/or otherwise inappropriate or objectionable image content. The disclosed technology can include one or more software processes that execute on the computer itself and are capable of monitoring and intercepting image content displayed thereon that may affect, for example, the computer's desktop, regardless of the source of such image content. The disclosed technology can intercept or “trap” operating system (OS) messages, such as window events, associated with a display. Once trapped, the disclosed system can analyze one or more active windows appearing on the computer's desktop to detect whether such windows contain images. If the active windows contain images, then the image is analyzed and a probability is computed that is indicative of a likelihood that the image contains objectionable content (e.g., pornography). If the probability exceeds a certain threshold then an event can be generated and communicated to an administrator system. In response to receiving an event pertaining to objectionable content, an administrator and/or administrative software process can instruct designated staff to further investigate the objectionable content, including a user's interaction therewith, and to undertake other appropriate human resource and/or legal actions as necessary.

In one illustrative embodiment, the disclosed technology can be deployed in a client-server configuration in which client computers perform most, if not all, of the interception and image analysis methodology described herein and forward events or other messages indicative of the results of such processing to one or more administrator processes executing on a server that is communicatively coupled to the clients. In another embodiment, the disclosed technology can be performed entirely within a digital data processing device, without involving any external processes and/or systems.

In one illustrative embodiment, the disclosed technology can be used to develop systems and perform methods in which objectionable content (e.g., pornographic content, pedophilic content, illegal content, immoral content, user-specified content, etc.) within a displayed image is detected. In this embodiment, the disclosed technology can detect the formation of one or more windows on a display of a digital data processing device and particular “windows-of-interest” can be further identified from the set of detected windows based on, for example, a window size, a window visibility, and/or a window classification. Each of the windows-of-interest is capable of displaying one or more graphical images and a list of such windows-or-interest can be maintained in a list, which may facilitate subsequent image analysis as further described herein. The graphical images that may displayed within one or more windows-of-interest can, for example, originate from or be based on a file/track on a DVD, a file on a CD-ROM, a file on a computer-readable memory (e.g., volatile memory, nonvolatile memory, etc.), a segment of streaming video, a digital representation of a photograph, a scanned image, and/or the like. An exemplary list can include indicia that uniquely identifies particular windows, as well as other information, such as, without limitation, the status (e.g., active) of the windows.

Pixel groupings associated with one or more graphical images displayed within a particular window-of-interest can be analyzed in response to one or more intercepted messages (e.g., messages issued by an operating system executing on a digital data processing device) associated with the particular window-of-interest and a probability that the analyzed graphical image includes objectionable content can be subsequently computed. Pixel groupings can correspond to subsets of pixels within quadrants of a particular window-of-interest and/or within a central region of a graphical image displayed within the particular window-of-interest. Analysis of the pixel groupings may include evaluating color attributes of substantially adjacent pixels. Further, an intercepted message can, for example, be based on a user's interaction with one or more windows-of-interest, such as one or more mouse movements and/or keyboard entries directed at or affecting such windows. The intercepted messages may also correspond to changes in the graphical images displayed within the windows-of-interest. A probability computed from an analysis of pixel groupings can serve as a basis for classifying an analyzed graphical image as being objectionable. The above described methodology can be performed, at least in part, on a client computer that displays particular windows-of-interest and indicia associated with a classified image can be transmitted from the client computer to an administration software process executing on a server computer that is communicatively coupled to the client computer.

The disclosed technology can also re-analyze one or more pixel groupings at periodic time intervals and re-compute a probability that a previously-analyzed graphical image includes objectionable content based on, for example, one or more time-based changes in the pixel attributes of corresponding pixel groupings. Any such re-computed probabilities may also serve as a basis for re-classifying the previously-analyzed graphical image.

### BRIEF DESCRIPTION OF THE DRAWINGS

The foregoing discussion will be understood more readily from the following detailed description of the disclosed technology, when taken in conjunction with the accompanying drawings in which:

FIG. 1 illustrates various exemplary sources from which objectionable content may originate;

FIG. 2 illustrates an exemplary client-server environment in which the detection of objectionable content on a client computer may result in the transmission of an alert message to an administration process executing on a server computer;

FIG. 3 schematically illustrates an exemplary architecture, including illustrative software processes, events, and data, that may be used in detecting objectionable content within images and reporting at least the presence of such objectionable content to an administrator for further evaluation and/or corrective action;

FIG. 4 illustrates an exemplary methodology for identifying particular windows-of-interest that may monitored for detection of any objectionable content within images displayed therein;

FIG. 5 illustrates an exemplary methodology for determining whether the content of a window-of-interest is to be subjected to an image analysis evaluation;

FIG. 6 illustrates exemplary sets of pixel groupings within an image that may be used to identify whether the image has changed and thus whether additional analysis may be necessary to re-evaluate the image's content;

FIG. 7 illustrates how a window containing a multitude of exemplary images may be partitioned to identify particular image regions warranting further image analysis;

FIG. 8 illustrates an exemplary methodology for analyzing an image within a window-of-interest for objectionable content; and

FIG. 9 illustrates an exemplary methodology for determining whether a “window close” event warrants the generation of events pertaining to the detection of objectionable content.

### DETAILED DESCRIPTION

Unless otherwise specified, the illustrated embodiments can be understood as providing exemplary features of varying detail of certain embodiments and therefore, unless otherwise specified, features, components, modules, elements, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and unless otherwise specified, can be altered without materially affecting or limiting the disclosed technology.

For the purposes of this disclosure, the term “substantially” can be broadly construed to indicate a precise relationship, condition, arrangement, orientation, and/or other characteristic, as well as, deviations thereof as understood by one of ordinary skill in the art, to the extent that such deviations do not materially affect the disclosed methods and systems.

For the purposes of this disclosure, the term “process” or “software process” can be broadly construed to refer to the execution of instructions that interact with operating parameters, message data/parameters, network connection parameters/data, variables, constants, software libraries, and/or any other elements needed for the proper execution of the instructions, within an execution environment in a memory of a digital data processing device; that causes a processor to control the operations of the data processing device in accordance with the desired functionality of an operating system, software application program, and/or any other type of generic or specific-purpose application program (or subparts thereof). Those skilled in the art will recognize that the various processes discussed herein are merely exemplary of the functionality performed by the disclosed technology and thus such processes and/or their equivalents may be implemented in commercial embodiments in various combinations and quantities without materially affecting the operation of the disclosed technology.

For the purposes of this disclosure, a digital data processing device can be construed broadly to refer to a personal computer, computer workstation (e.g., Sun, HP), laptop computer, server computer, mainframe computer, handheld device (e.g., personal digital assistant, Pocket PC, cellular telephone, etc.), information appliance, or any other type of generic or special-purpose, processor-controlled device capable of receiving, processing, displaying, and/or transmitting digital data. A processor refers to the logic circuitry that responds to and processes instructions that drive digital data processing devices and can include, without limitation, a central processing unit, an arithmetic logic unit, an application specific integrated circuit, a task engine, and/or any combinations, arrangements, or multiples thereof.

For the purposes of this disclosure, a data communications network can refer to a series of network nodes (e.g., client nodes, server nodes, etc.) that can be interconnected by network devices and communication lines (e.g., public carrier lines, private lines, satellite lines, etc.) that enable the network nodes to communicate. The transfer of data (e.g., messages) between network nodes can be facilitated by network devices, such as routers, switches, multiplexers, bridges, gateways, etc., that can manipulate and/or route data from an originating node to a destination node regardless of any dissimilarities in the network topology (e.g., bus, star, token ring, etc.), spatial distance (local, metropolitan, wide area network, etc.), transmission technology (e.g., TCP/IP, Systems Network Architecture, etc.), data type (e.g., data, voice, video, multimedia, etc.), nature of connection (e.g., switched, non-switched, dial-up, dedicated, virtual, etc.), and/or physical link (e.g., optical fiber, coaxial cable, twisted pair, wireless, etc.) between the originating and destination network nodes.

For the purposes of this disclosure, the term “window” can be construed broadly to refer to a quadrilateral viewing area on a display screen of a digital data processing device as part of a graphical user interface, where one or more of such windows displayed on the display screen may further display content (e.g., graphical images, text, etc.) that may be independent of content displayed in other windows or in other areas of the display screen. Similarly, the term “window-of-interest” can be construed broadly to refer to a window that is capable of displaying at least some graphical image content.

For the purposes of this disclosure, the terms “image,” “graphical image,” and “graphical image content” are interchangeable and can be construed broadly to refer to data representations facilitating display of at least one or more pictorial (e.g., life-like) objects. Similarly, the term “objectionable content” can be construed to refer to at least one portion of an image that includes one or more pictorial objects and/or parts thereof that have been deemed or that may be deemed to be offensive, inappropriate, and/or otherwise unsuitable or undesireable to a particular viewer and/or groups of viewers. By way of non-limiting example, objectionable content may include one or more of the following, separately or in any combination or multitude: pornographic material, pedophilic material, sexually explicit material, violent imagery, illegal material, immoral material, and/or any other type of pictorial content that may be deemed objectionable by a user, a viewer, an administrator, a court of law, and/or other types of entities.

For the purposes of this disclosure, the term “pixel” can be construed to refer to the smallest discrete component of an image displayed on a display screen of a digital data processing device. Similarly, a “pixel grouping” can refer to an arrangement including more than one pixel.

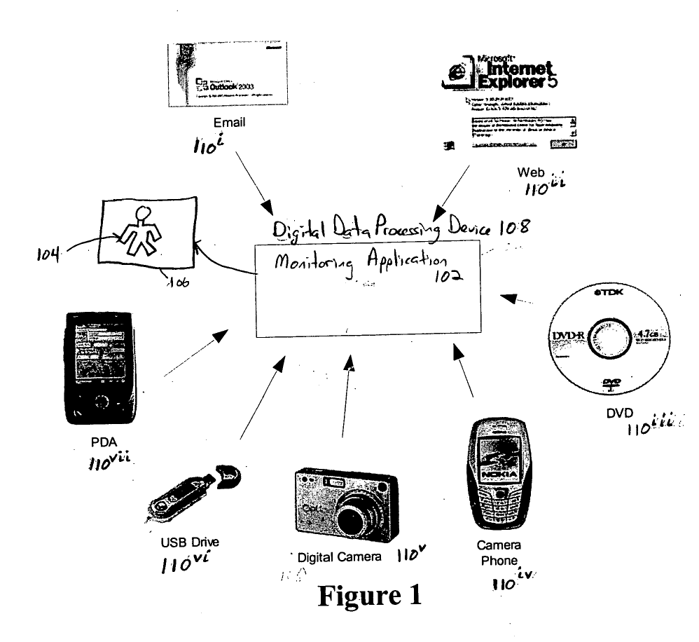

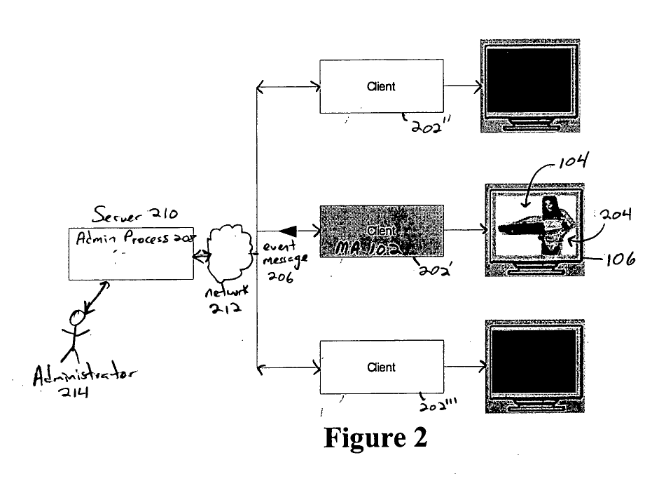

In brief overview and with reference to FIG. 1, at least some aspects of the disclosed technology can be embodied within a software application program 102 (referred to hereinafter as the “monitoring application”) that can monitor one or more images 104 displayed on a display screen 106 of a digital data processing device 108 for objectionable content, regardless of whether such images 104 were received via electronic mail messages, web-based content, DVDs, CDROMS, camera phones, digital cameras, USB memory devices, personal digital assistants, and/or any other type of image source 110. A monitoring application 102 may execute on and monitor images 104 displayed on the same digital data processing device 108 without reporting a detection of any objectionable content to external processes or entities. Alternatively and with reference to FIG. 2, a monitoring application 102 may execute on a client computer 202 to detect objectionable content 204 within one or more images 104 displayed on a display screen 106 thereof, where the monitoring application 102 may transmit one or more event messages 206 to an administration process 208 executing on a server computer 210 that is communicatively coupled to the client computer 202 via a network 212. A monitoring application 102 may also track user interactions with various application programs (e.g., web browser) that display objectionable content 204 and may further provide representations of displayed images 104 that are identified as containing objectionable content 204 to an administration process 208 for subsequent evaluation by an administrator 214 or other authorised entity. In one embodiment, the monitoring application 102 can be instantiated by an administrator 214 and/or on a periodic basis. Alternatively or in combination, the monitoring application can be instantiated upon the system boot-up or log-in process of a client computer 202. Regardless of how the monitoring application 102 is instantiated, software processes executing as part of the monitoring application 102 can track user interactions with images, windows, and/or application programs of interest using, for example, window hooking mechanisms provided by an operating system (not shown) executing on the corresponding digital data processing device 108, 102.

As is known to those skilled in the art, window hooking mechanisms can be provided by, for example, message-based operating systems, such as the operating systems produced by the Microsoft Corporation of Redmond Wash., USA. In such operating systems, actions requested by a user generate one or more corresponding messages that carry out the action. These messages are passed between objects and carry with them information that gives a recipient process more detail on how to interpret and act upon the message. A developer can develop software that manipulates, modifies, and/or discards messages bound for particular objects within the operating system using such window hooking mechanisms (along with sub-classing capabilities) and thus can modify the behavior of the operating system.

As is known to those skilled in the art, a hook is a function created as part of a dynamic link library (“DLL”) or application program that monitors the internal operations of an operating system. A hooking function may be called every time a certain event occurs, such as, for example, when a user presses a key on a keyboard or moves a mouse. Operating systems typically support two types of hooks—global or local. A “local” hook is one that monitors events or actions associated with a specific program (or thread). A “global” hook monitors events or actions associated with an entire system (all threads). Both types of hooks may be configured in a substantially similar manner, although a local hook may be called within a program that is being monitored, whereas a global hook is typically stored and loaded from a separate DLL.

Hooks provided within Microsoft's Windows® operating systems may be installed by calling a SetWindowsHookEx function and specifying the type of hook that called the hook procedure, as well as whether the procedure is associated with all threads in a common desktop as the calling thread or with a particular thread, and a pointer to the procedure entry point. A global hook procedure may be placed in a DLL that is separate from an application program installing the hook procedure. The installing application typically has a handle to the appropriate DLL module before it can install the hook procedure. To retrieve a handle to a DLL module, the LoadLibrary function with the name of the DLL can be called. After obtaining the handle, the GetProcAddress function can be called to retrieve a pointer to the hook procedure. Further, the SetWindowsHookEx function can be used to insert an address of the hook procedure in a proper location within a hook chain.

The disclosed technology can use one or more global hook procedures in its operations. For example, a monitoring application 102 can issue a LoadLibrary call to a hooking DLL, which invokes a method that in turn calls a SetWindowsHookEx function for each WH_CALLWNDPROCRET, WH_MOUSE, WH_GETMESSAGE, and WH_SHELL methods. The messages that are trapped by these hooks can be analyzed and appropriate notification messages can be sent to the monitoring application 102 for further action.

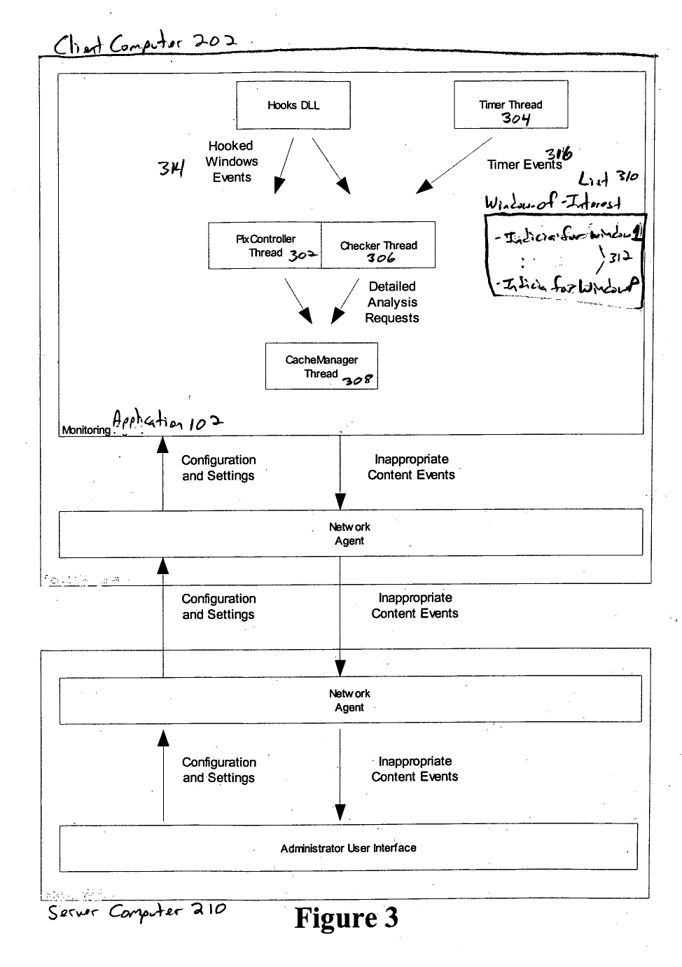

In one illustrative embodiment and with reference to FIG. 3, a monitoring application 102 can include four threads—a PixController thread 302 that handles application messages to the monitoring application 102 from a user and/or from other windows, a Timer thread 304 that “wakes up” periodically to perform time based inspection of image content, a Checker thread 306 that receives and processes messages that trigger image inspections (such as Mouse Left Button Up and Window Resize events), and a CacheManager thread 308 that performs detailed image analysis and generates and stores detection events when an image 104 is detected with a relatively high probability that such image 104 contains objectionable content 204. The PixController thread 302 can receive messages (e.g., Application Created, Application Destroyed, Window Created, Window Destroyed, Window Resized or Repositioned, and/or Application Activated messages) from hooked programs using a WM_COPYDATA inter process communication message.

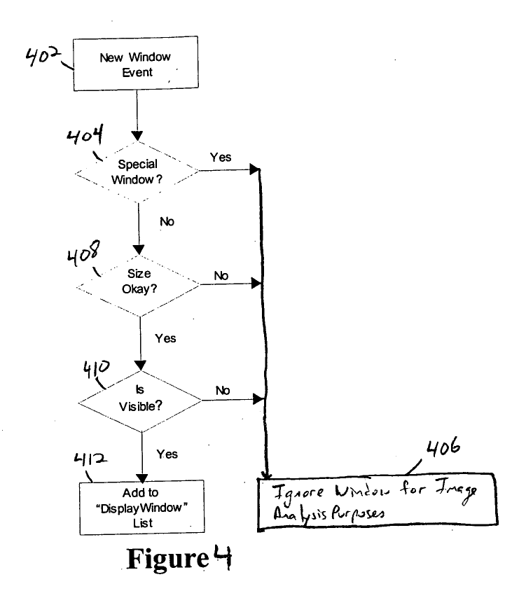

A monitoring application 102 can maintain a list 310 of “windows-of-interest” 312 that are capable of displaying images 104 that may include objectionable content 204. When a new window is created, the monitoring application 102 receives a message indicative of its creation via the above-identified hooking mechanism. The monitoring application 102 can examine the newly-created window and determine whether it is a window-of-interest 312. The monitoring application 102 can distinguish windows-of-interest 312 that are capable of displaying graphical images from other types of windows. More particularly and with reference now also to FIG. 4, the monitoring application 102 can receive a message indicative of the creation of a new window (402) and can subsequently make a determination as to whether the newly-created window is a special window (e.g., such as buttons that are incapable of displaying images) (404). If the monitoring application 102 classifies the newly-created window as a special window, then that window is not subjected to any further analysis by the application 102 (406). However and if the newly-created window is not a special window, then the monitoring application 102 examines the size of the window to ascertain whether the window is likely to display objectionable content (408).

Since windows containing objectionable content are typically of a certain size and aspect ratio (e.g., not too small, too thin, or too narrow), the monitoring application 102 can execute an algorithm that processes window size and aspect ratio information to generate a probability measure that can serve as a basis for deciding whether the newly-created window is a window-of-interest 312. Once such exemplary algorithm may involve computing a window area from the window's height and width and dividing the square root of this window area by a threshold number in order to determine an “area ratio.” Area ratios that exceed 1 can be set to 1. This exemplary algorithm can also compute an aspect ratio based on the greater of the window width or height divided by the lesser of the two. A Gaussian aspect ratio of this aspect ratio relative to an ideal aspect ratio can then be computed using a normal distribution formula with a mean value and standard deviation. An overall probability can then be computed to be the area ratio multiplied by the Gaussian aspect ratio. This probability can serve as the basis for making the determination as to whether the size of a newly-created window is sufficient for a window-of-interest (408).

The monitoring application 102 can also make a determination as to whether a newly-created window is visible or not based on, for example, the windows attributes (410). Windows that are not visible to a viewer may be subsequently ignored for image processing purposes (406). Otherwise the monitoring application 102 can classify the newly-created window as a window-of-interest and/or store indicia of the newly-created window in the list 310 of windows-of-interest (412). Keeping an active list 310 of windows-of-interest can reduce the processing burden when inspecting such widows for image content.

Once a window-of-interest 312 is added to the list 310, the Checker thread 306 can intercept and analyze messages (such as, for example, mouse down/up (left button) messages and/or key down and up messages for special keys including page down, page up, and arrow keys) associated with these windows using the hooking mechanism described previously. Horizontal and vertical scroll events and Enter and Exit Menu events 314 may also be intercepted. These intercepted message can be subsequently analyzed to ascertain whether images within the window-of-interest should be subjected to further image analysis.

The Timer thread 304 can be configured to periodically check the content of one or more windows-of-interest 312. This timer facility can, for example, prove useful in detecting objectionable content 204 within displayed images 104 that may be changing independently of any user interactions (e.g., such as when the window displays streaming video content). If images within such windows are found to have been modified, the Timer thread 304 can generate one or more timer events 316 that may subject a window-of-interest to a detailed image analysis.

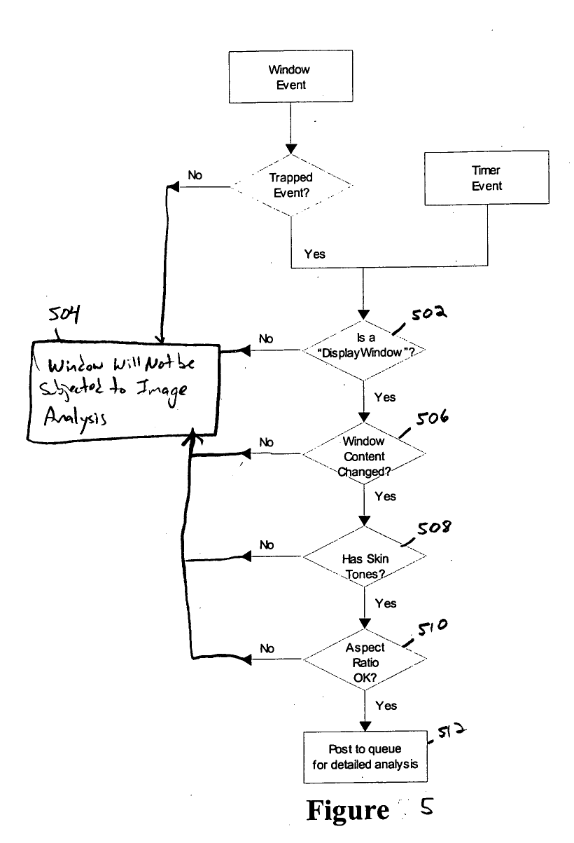

With reference now also to FIG. 5, an illustrative decision making process that may be performed by a monitoring application 102 with respect to whether one or more images within a window warrant detailed image analysis begins with window events 314 trapped by the Checker Thread 306 and/or with timer events 316 generated by the Timer thread 304. These events 314, 316 can trigger the methodology described above in connection with FIG. 4 to ascertain whether the events pertain to a window-of-interest 312 (502). If a determination is made that the window is not a window-of-interest 312, then such window need not be subjected to a detailed image analysis 504. Otherwise, a determination can be made as to whether the contents of the window-of-interest 312 have changed since a prior evaluation (506). If the window contents are deemed to have changed, then the monitoring application 102 can examine one or more pixels and/or pixel groupings to determine whether such pixels depict skin tones (508). If the pixels and/or pixel groupings exhibit a skin tone above a predetermined threshold, then the monitoring application 102 can further compute window size and/or aspect ratio metrics for the window-of-interest, as previously discussed (510). Windows that fulfill the above-described process may be placed in a queue where they can be subsequently processed by, preferably, a lower priority, thread that will conduct a detailed image analysis of the image content displayed in such windows (512).

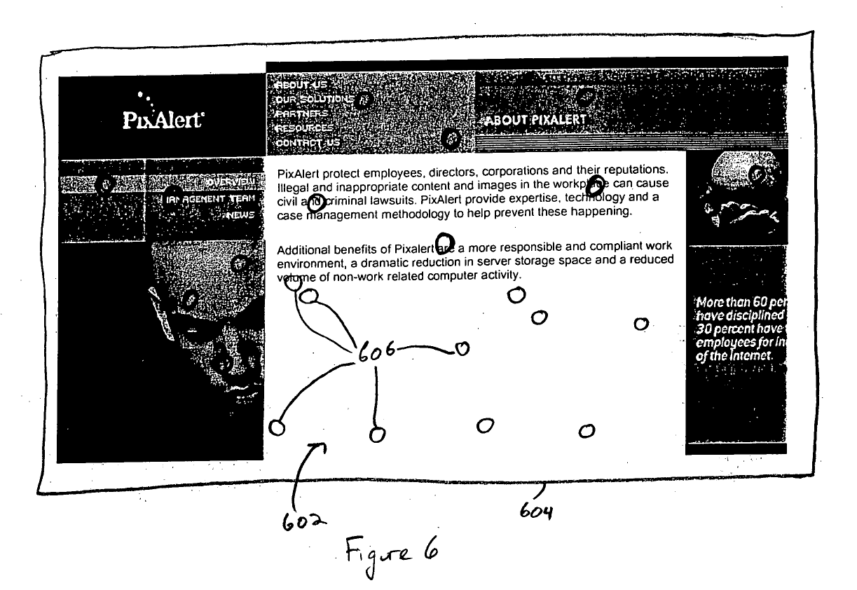

In more detail and with reference to FIG. 6, a determination of whether the image content 602 of a window 604 has changed over time (506) can involve an examination of a set of random pixels 606 from within the displayed image 602. The pixels 606 can be taken at random, but are preferably selected to ensure a spread across the window 604. For example, one eighth of the pixels 606 can be selected from each of the 4 quadrants of the window 604 and from the center region of the image 602. The coordinates (e.g., X,Y) and color values (e.g., red, green, and blue (RGB)) of the selected pixels 606 can also be stored in a data structure for subsequent access by the monitoring application 102. When a window 604 is examined to see if its image content 602 has changed, the attributes of the pixels 606 can be compared with those of corresponding pixels that were stored during a prior evaluation period. For example, the Red, Green and Blue values of each pixel can be examined and their values in the YCbCr color space can be calculated. The YCbCr color space is widely used for digital video. In this format, luminance information is stored as a single component (Y), and chrominance information is stored as two color-difference components (Cb and Cr). Cb represents the difference between the blue component and a reference value. Cr represents the difference between the red component and a reference value. The YCbCr values can be compared to a range of values and such comparison may serve as one possible basis for whether image analysis is appropriate. In one embodiment, if more than 75% of the pixel attributes remain unchanged, then the image 602 is considered not to have changed. Following this evaluation, the new set of pixel attribute values can be stored to support future content change evaluations.

The selected pixels can also be further analyzed to serve as a basis for detecting the presence of skin tones within an image 602 displayed in a window 604. The HSV color space (hue, saturation, value) has traditionally been used by people who are selecting colors (e.g., of paints or inks) from a color wheel or palette, because it corresponds better to how people experience color than the RGB color space does. As hue varies from 0 to 1.0, the corresponding colors vary from red through yellow, green, cyan, blue, magenta, and back to red, so that there are actually red values both at 0 and 1.0. As saturation varies from 0 to 1.0, the corresponding colors (hues) vary from unsaturated (shades of gray) to fully saturated (no white component). As value, or brightness, varies from 0 to 1.0, the corresponding colors become increasingly brighter. The HSV hue and saturation of each pixel can be computed and may be compared with a prescribed range of values as a basis for classifying a pixel as a skin pixel. If a skin pixel is identified, then a neighboring diagonal pixel can be examined to ascertain whether is also is a ski pixel. If the neighboring pixel has a different HSV hue and/or saturation value and is still classified as a skin pixel, then there is a greater probability that this portion of the image includes skin, since skin is not uniform in color. The number of skin pixels within the image or particular region of the image can be compared against a threshold value in order to determine whether the image itself can be classified as skin.

A window-of-interest 604 may contain primarily text (e.g., a word processing window), primarily an image (e.g., an image viewing application) or a combination of images and text (e.g., a web page viewable via an Internet browser). An examination of a window-of-interest 604 for the purposes of detecting objectionable content is facilitated by identifying particular image regions within the overall displayed image so that computing resources are not expended on areas of the displayed image that may contain primarily text.

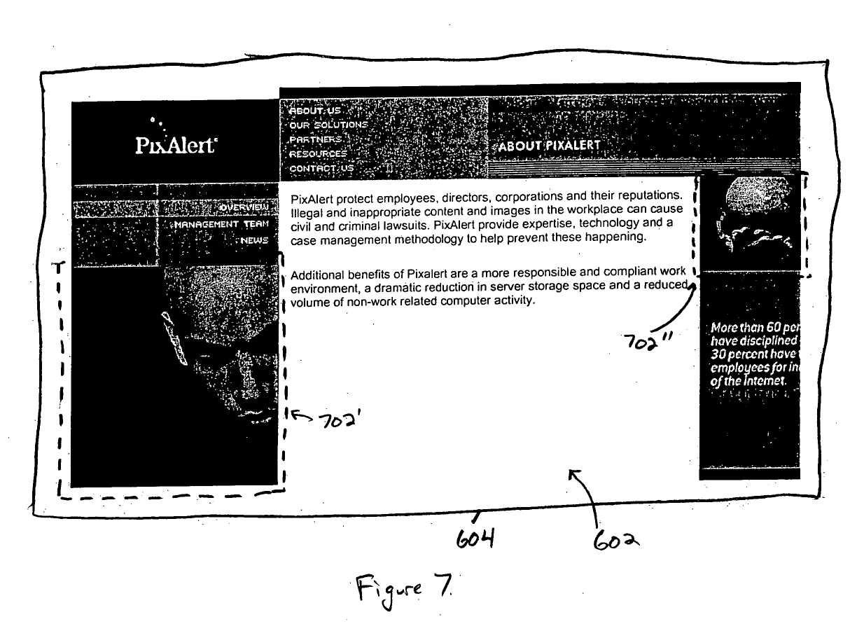

In one illustrative embodiment and with reference now to FIG. 7, one or more images 602 displayed within a window-of-interest 604 can be examined to identify well-bounded regions or boxes 702 that may constitute an image. An exemplary algorithm that can perform this examination involves finding edges, then finding corners and finally finding a full “box” within the window-of-interest. To find an edge, a random pixel is selected and then pixels that are, for example, five positions above and below that pixel are evaluated (as long as the window boundary is not overstepped). The blue color values of substantially adjacent pixels can then be compared and if, for example, the blue color values of a pixel grouping are the same, but differ from the blue values of an adjacent pixel grouping, then there is a significant probability that at least some of these pixels reside on an edge. To find a corner, the blue values of pixels directly underneath a random pixel and then one pixel to the left of these pixels can be examined. If the blue value of the pixel underneath random pixel and then to the left of that pixel are the same, then it is probable that this is a bottom right corner of the a box 702. In a similar fashion, by examining the pixels directly above the random pixel and its adjacent pixels, the top right corner of the box may also be detected.

A similar procedure can be used to detect the other corners of the box 702, by moving horizontally from the bottom right corner and then from the top right corner toward the left of the image and comparing blue values against the pixel values of one pixel up from or down from the candidate pixel. Once all 4 corners have been detected, then the dimensions of the discovered box can be examined and if such dimensions are sufficiently large enough, then a box is deemed to have been discovered within the image 602. Each discovered box in turn can then be analyzed for objectionable content. In addition, the overall window can be analyzed as a single image. The highest probability score from the individual boxes can be compared to an overall score for an entire window and the higher probability can then be associated with that window.

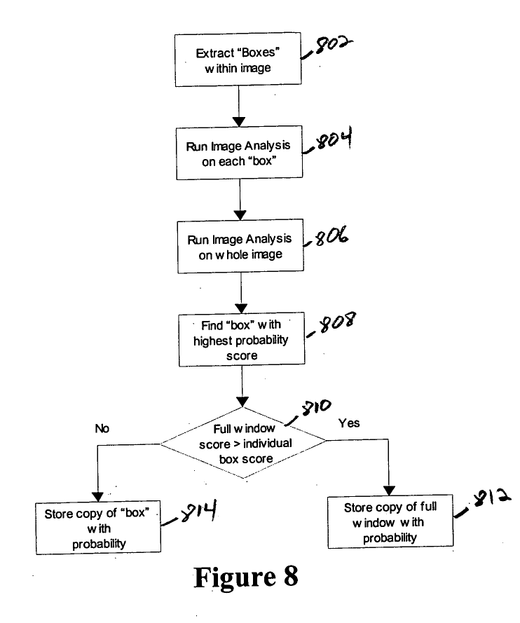

In one illustrative operation and with reference now also to FIG. 8, the monitoring application 102 can extract/identify boxes 702 within an image 602 displayed in a window-of-interest 604 (802). A detailed image analysis can then be performed on each box 702 to compute a probability as to whether the image region within the box 702 contains objectionable content (804). A detailed image analysis can also be performed on the entirety of the image 602 by, for example, evaluating all relevant pixels within the image 602 and/or by evaluating the combination of boxed regions in the image 602 (806). A particular box 702 exhibiting the highest probability score can then be determined (808) and can be compared with the probability score of the entire image displayed in the window (810). If the score of the entire image exceeds that of a boxed image region, then the entire image and/or its probability score can be stored and perhaps subsequently communicated to an administrator (812). Otherwise, the image region within the box 702 and/or its probability score can be stored and subsequently communicated (814).

In one illustrative embodiment, a detailed image analysis that may be performed for a particular image and/or image region may involve initially classifying the image as either grey scale or color by, for example, examining whether each individual pixel is a grey scale value—(red=blue=green). In this embodiment approximately 5% of the pixels in the image can be sampled at random and a histogram can be subsequently created by calculating the average of the red, green and blue values for each pixel in the sample and incrementing a count associated with that average value. Characteristics of the histogram, such as, for example, the distribution of grey scale, minimum value, maximum value, and/or weighted sum can be computed and a probability score indicative of the likelihood of having objectionable content can be determined by comparing such characteristics with similar characteristics identified for “idealized” images that include objectionable content. The computed probabilities can also be combined with an aspect ratio to produce an overall probability score.

Images within a window-of-interest that have been determined to include objectionable content can be stored in a cache of other such images along with their associated probabilities that the content is objectionable. This cached information may be accessed by an administrator for subsequent evaluation. If a window-of-interest is analyzed several times (e.g., when a web browser loads a new page), then, in some embodiments, only the image with the highest probability score is stored in the cache rather than each such image in order to reduce the storage load on the cache.

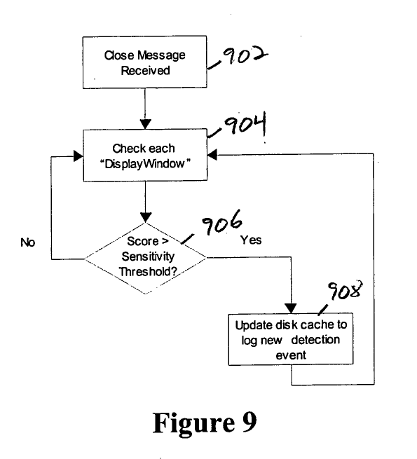

With reference now to FIG. 9, when a close message is received indicating that a window has been destroyed (for example the browser window is closed) (902), each window-of-interest can be checked (904) to determine whether the probability associated with the displayed image in the cache is greater than a user-defined sensitivity threshold (906). If the probability exceeds the threshold, then the image can be saved along with key information relating to the date and time, user, machine, etc. associated with such image. The information can be stored in encrypted format and ideally in an area to which a standard user has no access.

Configuration parameters can also be established to govern the rate at which new events are generated in order to ensure that the system does not become overloaded with images and also that the rate of event generation is not so infrequent as to ignore inappropriate/objectionable behavior.

In an exemplary stand alone environment (for example in the home) an administration process can be periodically executed on the same machine that had been monitored by the monitoring application 102 and the administration process can access and display any stored images that were previously identified as potentially being objectionable.

In an exemplary client-server environment, a monitoring application executing on a client computer can communicate any changes in its set of saved images to a server computer at substantially any time prior to, concurrently with, or following a user's log-in to the client computer. Some embodiments, may communicate detections of objectionable content in substantially real time, whereas other embodiments may prefer to communicate such detections in a batch mode to reduce the burden on network resources during peak usage periods.

An administration process can permit the an administrator to in the first instance see the number of images detected on each system and the administrator can then query individual systems to retrieve the stored images containing objectionable content. The administration process can further provide a number of additional functions, such as changing the sensitivity threshold and/or deleting the cache contents on one or more monitored computers.

Although the disclosed technology has been described with reference to specific embodiments, it is not intended that such details should be regarded as limitations upon the scope of the invention.

1. A method of detecting objectionable content within a displayed image, the method comprising:
maintaining a list of windows-of-interest, each of the windows-of-interest being capable of displaying at least one graphical image therein;
intercepting messages associated with the windows-of-interest;
in response to at least one of the intercepted messages directed at a particular one of the windows-of-interest, analyzing pixel groupings of at least one particular graphical image displayed therein to compute a probability that the analyzed graphical image includes objectionable content; and
based on the computed probability, classifying the analyzed graphical image as being objectionable.

2. The method of claim 1, wherein objectionable content corresponds to at least one of a pornographic content, a pedophilic content, an illegal content, an immoral content, and a user-specified content.

3. The method of claim 1, wherein the intercepted messages correspond to messages issued by an operating system executing on a digital data processing device.

4. The method of claim 3, wherein the intercepted messages are based on a user interaction with at least one of the windows-of-interest.

5. The method of claim 4, wherein the user interaction corresponds to at least one of a mouse movement and a keyboard entry.

6. The method of claim 1, wherein the intercepted messages correspond to changes in the graphical images displayed within the windows-of-interest.

7. The method of claim 1, wherein the list of windows-of-interest includes a status of such windows.

8. The method of claim 1, wherein the pixel groupings correspond to subsets of pixels within quadrants of the particular window-of-interest and within a central region of the graphical image displayed in the particular window-of-interest.

9. The method of claim 1, wherein analyzing pixel groupings comprises evaluating color attributes of substantially adjacent pixels.

10. The method of claim 1, wherein the graphical images displayed within the windows-of-interest originate from at least one of a file on a DVD, a file on a CD, a file on a computer-readable memory, a segment of streaming video, and a digital representation of a photograph.

11. The method of claim 1, further comprising:
detecting formation of a plurality of windows; and
identifying the windows-of-interest from the plurality of windows based on at least one of a window size, a window visibility, and a window classification.

12. The method of claim 1, further comprising:
re-analyzing the pixel groupings at periodic time intervals;
re-computing the probability that the analyzed graphical image includes objectionable content based on at least some time-based changes in the pixel attributes of corresponding pixel groupings; and
re-classifying the analyzed graphical image based on the re-computed probability.

13. The method of claim 1, wherein each of the steps are performed on a client computer displaying the windows-of-interest and the method further comprises transmitting indicia of the classified image from the client computer to an administration software process executing on a server computer.
